(19) United States
(12) Patent Application Publication
(10) Pub. No.: US 2003/0211377 A1
(43) Pub. Date: Nov. 13, 2003

(54) Fuel-cell based power source having internal series redundancy

(76) Inventors: Charles M. Holmes, Escondido, CA (US); Rajagopalan Sundar, San Diego, CA (US); Kenneth Dean Vail, San Diego, CA (US)

Correspondence Address: ROBROY R FAWCETT, 1576 KATELLA WAY, ESCONDIDO, CA, 92027, US

(21) Appl. No.: 10/141,631

(22) Filed: May 7, 2002

(51) Int. Cl. H01M 8/24; H01M 12/06

(52) U.S. Cl. 429/34; 429/27; 429/13

(57) ABSTRACT

The present invention can be embodied in a power source having internal redundancy for allowing continued operation of a load such as an electric vehicle, as well as related methods. The power source comprises a first plurality of fuel cell stacks, a second plurality of fuel cells, and a third plurality of bypass devices. Each power converter can receive input electrical power from one of the fuel cell stacks and generates output electrical power at a predetermined output voltage. The power converters can be connected in series between terminals of the power source. Each bypass device can be coupled to one of the power converters for providing a current path if the power converter is unable to provide output electrical power. Each power converter can have selectable output voltages for increasing its output voltage if one of the power converters is not supplying power for the power source.

### FIELD OF THE INVENTION

The present invention relates generally to fuel cells, and, more specifically, to redundancy in a plurality of series-connected fuel-cell based power supplies or in an electrochemical power system or a load (e.g., electric vehicle) employing same.

### RELATED ART

An electric vehicle may have an electrical propulsion bus coupled to a power source. The power source may include a plurality of series-connected power supplies. A disadvantage of series connected power supplies is that a failure in one power supply may prevent power from reaching the electrical propulsion bus. The failure may result in the vehicle being completely disabled in an inconvenient or dangerous location.

### SUMMARY

In one aspect, the invention comprises a fuel-cell based power source for supplying electrical power to first and second power source terminals. A fuel-cell based power source in accordance with the invention comprises a first plurality, having a value v, of fuel cell stacks, each fuel cell stack for generating electrical power. This power source also comprises a second plurality, having a value w in the range from 1 to v, of power converters. Each power converter typically is operably coupled to at least one of the first plurality of fuel cell stacks for receiving input electrical power from the fuel cell stack(s) and converting the input electrical power to output electrical power at a predetermined output voltage. This second plurality of power converters are connected in series between the first and second power source terminals such that the voltage across the first and second power source terminals is the sum of the output voltages of the second plurality of power converters. The power source in accordance with the invention further comprises a third plurality, having a value x in the range from 1 to w, of bypass devices. Each bypass device generally is operably coupled to at least one of the second plurality of power converters for providing a current path around the respective power converter(s) if the respective power converter(s) do(es) not provide output electrical power.

In another aspect, the invention comprises a fuel-cell based power source for supplying electrical power to first and second power source terminals. A fuel-cell based power source in accordance with the invention comprises a first plurality, having a value v, of fuel cell stacks, each fuel cell stack for generating electrical power. This power source also comprises a second plurality, having a value w in the range from 1 to v, of power converters. Each power converter generally comprises input terminals that are operably coupled to at least one of the fuel cell stacks for receiving input electrical power from the fuel cell stack(s), and a positive output terminal and a negative output terminal for providing output electrical power at a predetermined output voltage. In this configuration, the power converter is capable of converting the input electrical power to the output electrical power. The power source in accordance with the invention further comprises a third plurality, having a value x in the range from 1 to w, of bypass diodes. Each bypass diode comprises a cathode that is operably coupled to the positive output terminal and an anode that is operably coupled to the negative output terminal of each of at least one of the power converters for providing a current path between each power converter's output terminals if the respective power converter is unable to provide output electrical power. This second plurality of power converters are connected in series between the first and second power source terminal such that the voltage across the first and second power source terminals is the sum of the voltages at the output terminals of the power converters.

In a further aspect, the invention comprises loads that each comprise at least one fuel-cell based power source in accordance with the invention. Suitable loads comprise lawn and garden equipment; radios; telephone; targeting equipment; battery rechargers; laptops; communications devices; sensors; night vision equipment; camping equipment; lights; vehicles; torpedoes; security systems; electrical energy storage devices for renewable energy sources; other electrical devices; equipment for which a primary and/or backup power source is necessary or desirable to enable the equipment to function for its intended purpose; military-usable variants of any of the above; and the like; and suitable combinations of any two or more thereof. In one embodiment, a suitable load comprises an electric vehicle.

In another aspect, the invention comprises methods for modulating the voltage of a fuel-cell based power source for supplying electrical power to first and second power source terminals. The methods comprise identifying at least one power converter of the power source that is unable to provide output electrical power at a predetermined output voltage across a positive output terminal and a negative output terminal of the power converter. In this step, each of the power converter(s) is operably coupled to at least one fuel cell stack of the fuel-cell based power source for receiving input electrical power from the fuel cell stack(s) and is capable of providing output electrical power at the predetermined output voltage. The methods further comprise providing a current path between the positive output terminal and the negative output terminal of at least one of the identified power converters that are not supplying power.

Alternatively or in addition, fuel-cell based power sources and/or loads and/or methods of modulating the voltage of a fuel-cell based power source in accordance with the invention can be characterized in that the associated predetermined output voltage is selectable from a fourth plurality, having a value of (y+1) in the range from 1 to x where y is the number of bypass diode(s) that each provide a current path around power converter(s) that are not supplying power, of different converter output voltages. Each of the fourth plurality of different converter output voltages is orderable from the first to the (y+1)^{th} converter output voltage according to ascending voltage magnitude.

Accordingly, there exists a need for fuel-cell based power sources and related techniques for allowing continued operation of loads comprising at least one of the fuel-cell based power sources in the event of a failure within the load's power source(s). The present invention satisfies these needs and provides further related advantages.

### BRIEF DESCRIPTION OF THE DRAWINGS

The accompanying drawings illustrate embodiments of the present invention. The components in the accompanying drawings are not necessarily to scale but, together with the description, serve to explain some principles of the invention.

FIG. 1A is a simplified block diagram of an electrochemical power source system.

FIG. 1B is a simplified block diagram of an alternate embodiment of an electrochemical power source system.

FIG. 1C is a schematic block diagram of an electric vehicle comprising a propulsion system with a power source having internal series redundancy, according to the present invention.

FIG. 2 is a block diagram of a power source comprising fuel-cell based power supplies connected in series and each having an anti-parallel bypass diode, according to the present invention.

FIG. 3 is a block diagram of a dc-to-dc power converter comprising selectable voltage levels, according to the present invention.

FIG. 4 is a line graph of output voltages for the series-connected power supplies of FIG. 2, according to the present invention.

FIG. 5 is a line graph of output voltages for the series-connected power supplies of FIG. 2 with one power supply not supplying an output voltage, according to the present invention.

FIG. 6 is a line graph of output voltages for the series-connected power supplies of FIG. 2 with one power supply not supplying an output voltage and the remaining power supplies having an increased voltage output, according to the present invention.

FIG. 7 is a line graph of output voltages for the series-connected power supplies of FIG. 2 with two power supplies not supplying an output voltage and the remaining power supplies having an increased voltage output, according to the present invention.

### DETAILED DESCRIPTION

As utilized herein, terms such as “approximately,” “about” and “substantially” are intended to allow some leeway in mathematical exactness to account for tolerances that are acceptable in the trade, e.g., any deviation upward or downward from the value modified by “approximately,” “about” or “substantially” by any value in the range(s) of up to 20% of such value.

As employed herein, the terms or phrases “in the range(s)” or “between” comprises the range defined by the values listed after the term “in the range(s)” or “between”, as well as any and all subranges contained within such range, where each such subrange is defined as having as a first endpoint any value in such range, and as a second endpoint (if any) any value in such range that is greater than the first endpoint and that is in such range.

As utilized herein, the term “logic” comprises hardware, software, and combinations of hardware and software, and the term “microprocessor” comprises “logic” possibly in combination with one or more electromechanical devices or apparatus, such as sensors or measuring devices or calculating devices or the like.

As employed herein, the term “indicate” and grammatical variants thereof comprise any machine or human perceptible form, such as a signal, a human perceivable meter reading, a logic perceivable meter reading, or the like, or suitable combinations of any two or more thereof.

Introduction to Fuel Cells and Electrochemical Power Systems Employing Fuel Cells

A hydrogen fuel cell is a fuel cell that uses a hydrogen-containing compound, such as hydrogen gas or liquid, as a fuel. A metal fuel cell is a fuel cell that uses a metal, such as zinc particles, as fuel. In a metal fuel cell, the fuel is generally stored, transmitted and used in the presence of a reaction medium, such as potassium hydroxide solution.

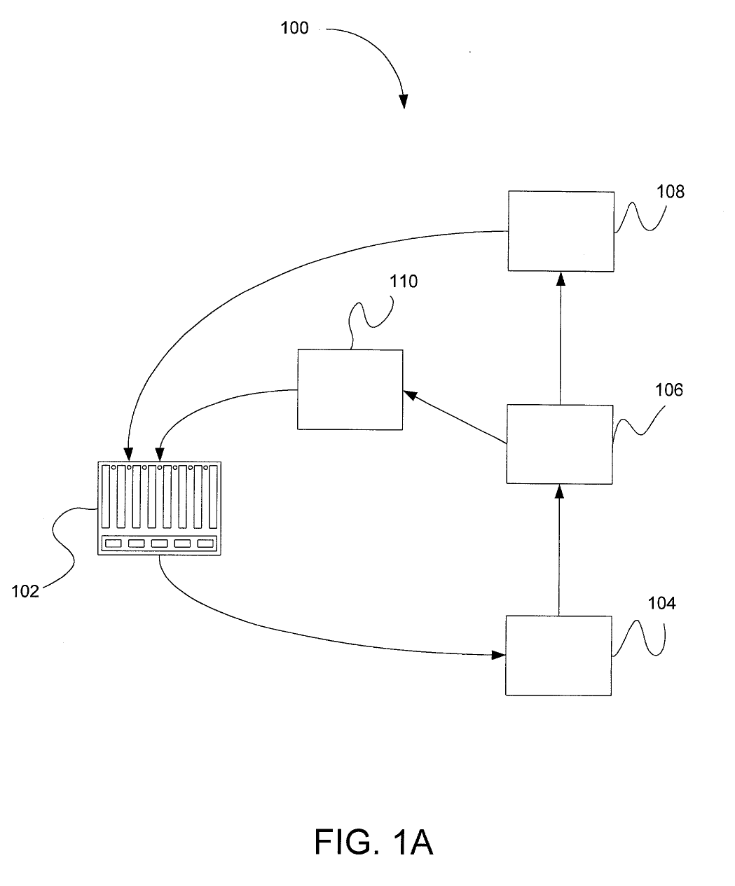

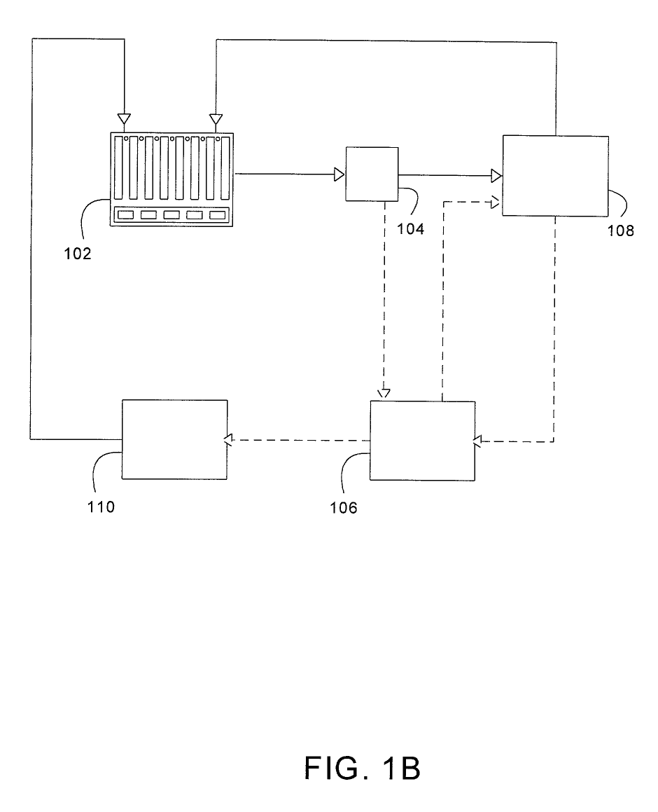

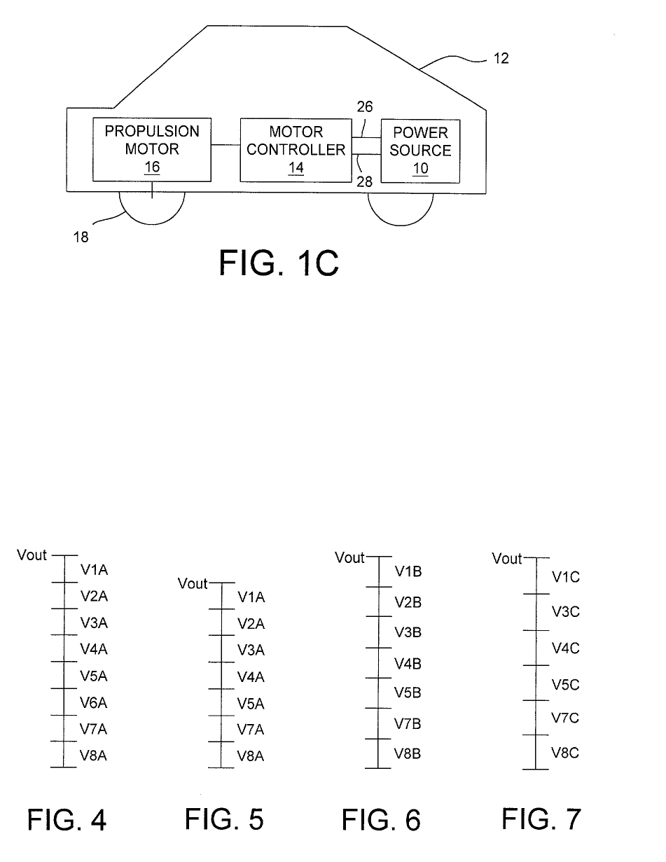

A block diagram of a fuel cell is illustrated in FIG. 1A. As illustrated, the fuel cell comprises a power source 102, an optional reaction product storage unit 104, an optional regeneration unit 106, a fuel storage unit 108, and an optional second reactant storage unit 110.

The power source 102 in turn comprises one or more individual cells each having a cell body defining a cell cavity, with an anode and cathode situated in each cell cavity. The individual cells can be coupled in parallel or series, or independently coupled to different electrical loads. In one implementation, they are coupled in series.

The anodes within the cell cavities in power source 102 comprise the fuel stored in fuel storage unit 108 or an electrode. Within the cell cavities of power source 102, an electrochemical reaction takes place whereby the anode releases electrons, and forms one or more reaction products. Through this process, the anodes are gradually consumed.

The electrons released from the electrochemical reaction at the anode flow through a load to the cathode, where they react with one or more second reactants from an optional second reactant storage unit 110 or from some other source. This flow of electrons through the load gives rise to an over-potential (i.e., work) required to drive the demanded current, which over-potential acts to decrease the theoretical voltage between the anode and the cathode. This theoretical voltage arises due to the difference in electrochemical potential between the anode (for example, in the case of a zinc fuel cell, Zn potential of −1.215V versus SHE reference at open circuit) and cathode (O₂ potential of +0.401V versus SHE reference at open circuit). When the cells are combined in series, the sum of the voltages for the cells forms the output of the power source.

The one or more reaction products can then be provided to optional reaction product storage unit 104 or to some other destination. The one or more reaction products, from reaction product storage unit 104 or some other source, can then be provided to optional regeneration unit 106, which regenerates fuel and/or one or more of the second reactants from the one or more reaction products. The regenerated fuel can then be provided to fuel storage unit 108, and/or the regenerated one or more second reactants can then be provided to optional second reactant storage unit 110 or to some other destination. As an alternative to regenerating the fuel from the reaction product using the optional regeneration unit 106, the fuel can be inserted into the system from an external source and the reaction product can be withdrawn from the system.

The optional reaction product storage unit 104 comprises a unit that can store the reaction product. Exemplary reaction product storage units include without limitation one or more tanks, one or more sponges, one or more containers, one or more vats, one or more canister, one or more chambers, one or more cylinders, one or more cavities, one or more barrels, one or more vessels, and the like, including without limitation those found in or which may be formed in a substrate, and suitable combinations of any two or more thereof. Optionally, the optional reaction product storage unit 104 is detachably attached to the system.

The optional regeneration unit 106 comprises a unit that can electrolyze the reaction product(s) back into fuel (e.g., hydrogen-containing compounds, including without limitation hydrogen; electroactive particles, including without limitation metal particles and/or metal-coated particles; electroactive electrodes; and the like; and suitable combinations of any two or more thereof) and/or second reactant (e.g., air, oxygen, hydrogen peroxide, other oxidizing agents, and the like, and suitable combinations of any two or more thereof). Exemplary regeneration units include without limitation water electrolyzers (which regenerate an exemplary second reactant (oxygen) and/or fuel (hydrogen) by electrolyzing water); metal (e.g., zinc) electrolyzers (which regenerate a fuel (e.g., zinc) and a second reactant (e.g., oxygen) by electrolyzing a reaction product (e.g., zinc oxide (ZnO)); and the like; and suitable combinations of any two or more thereof. Exemplary metal electrolyzers include without limitation fluidized bed electrolyzers, spouted bed electrolyzers, and the like, including without limitation those found in or which may be formed in a substrate, and suitable combinations of two or more thereof. The power source 102 can optionally function as the optional regeneration unit 106 by operating in reverse, thereby foregoing the need for a regeneration unit 106 separate from the power source 102. Optionally, the optional regeneration unit 106 is detachably attached to the system.

The fuel storage unit 108 comprises a unit that can store the fuel (e.g., for metal fuel cells, electroactive particles, including without limitation metal (or metal-coated) particles, liquid born metal (or metal-coated) particles, and the like; electroactive electrodes, and the like, and suitable combinations of any two or more thereof; for hydrogen fuel cells, hydrogen or hydrogen-containing compounds that can be reformed into a usable fuel prior to consumption; for alcohol fuel cells, alcohol or alcohol-containing compounds). Exemplary fuel storage units include without limitation one or more of any of the enumerated types of reaction product storage units, which in one embodiment are made of a substantially non-reactive material (e.g., stainless steel, plastic, or the like), for holding potassium hydroxide (KOH) and metal (e.g., zinc (Zn), other metals, and the like) particles, separately or together; a high-pressure tank for gaseous fuel (e.g., hydrogen gas); a cryogenic tank for liquid fuel (e.g., liquid hydrogen) which is a gas at operating temperature (e.g., room temperature); a metal-hydride-filled tank for holding hydrogen; a carbon-nanotube-filled tank for storing hydrogen; and the like; and suitable combinations of any two or more thereof. Optionally, the fuel storage unit 108 is detachably attached to the system.

The optional second reactant storage unit 110 comprises a unit that can store the second reactant. Exemplary second reactant storage units include without limitation one or more tanks (for example, without limitation, a high-pressure tank for gaseous second reactant (e.g., oxygen gas), a cryogenic tank for liquid second reactant (e.g., liquid oxygen) which is a gas at operating temperature (e.g., room temperature), a tank for a second reactant which is a liquid or solid at operating temperature (e.g., room temperature), and the like), one or more of any of the enumerated types of reaction product storage units, which in one embodiment are made of a substantially non-reactive material, and the like, and suitable combinations of any two or more thereof. Optionally, the optional second reactant storage unit 110 is detachably attached to the system.

In one embodiment of a fuel cell useful in the practice of the invention, the fuel cell is a metal fuel cell. The fuel of a metal fuel cell is a metal that can be in a form to facilitate entry into the cell cavities of the power source 102. For example, the fuel can be in the form of metal (or metal-coated) particles or liquid born metal (or metal-coated) particles or suitable combinations of any two or more thereof. Exemplary metals for the metal (or metal-coated) particles include without limitation zinc, aluminum, lithium, magnesium, iron, sodium, and the like. Suitable alloys of such metals can also be utilized for the metal (or metal-coated) particles.

In this embodiment, when the fuel is optionally already present in the anode of the cell cavities in power source 102 prior to activating the fuel cell, the fuel cell is pre-charged, and can start-up significantly faster than when there is no fuel in the cell cavities and/or can run for a time in the range(s) from about 0.001 minutes to about 1000 minutes without additional fuel being moved into the cell cavities. The amount of time which the fuel cell can run on a pre-charge of fuel within the cell cavities can vary with, among other factors, the pressurization of the fuel within the cell cavities, and the power drawn from the fuel cell, and alternative embodiments of this aspect of the invention permit such amount of time to be in the range(s) from about 1 second to about 1000 minutes or more, and in the range(s) from about 30 seconds to about 1000 minutes or more.

Moreover, the second reactant optionally can be present in the fuel cell and pre-pressurized to any pressure in the range(s) from about 0 psi gauge pressure to about 200 psi gauge pressure. Furthermore, in this embodiment, one optional aspect provides that the volumes of one or both of the fuel storage unit 108 and the optional second reactant storage unit 110 can be independently changed as required to independently vary the energy of the system from its power, in view of the requirements of the system. Suitable such volumes can be calculated by utilizing, among other factors, the energy density of the system, the energy requirements of the one or more loads of the system, and the time requirements for the one or more loads of the system. In one embodiment, these volumes can vary in the range(s) from about 10⁻¹² liters to about 1,000,000 liters. In another embodiment, the volumes can vary in the range(s) from about 10⁻¹² liters to about 10 liters.

In one aspect of this embodiment, at least one of, and optionally all of, the metal fuel cell(s) is a zinc fuel cell in which the fuel is in the form of fluid borne zinc particles immersed in a potassium hydroxide (KOH) electrolytic reaction solution, and the anodes within the cell cavities are particulate anodes formed of the zinc particles. In this embodiment, the reaction products can be the zincate ion, Zn(OH)₄²⁻, or zinc oxide, ZnO, and the one or more second reactants can be an oxidant (for example, oxygen (taken alone, or in any organic or aqueous (e.g., water-containing) fluid (for example and without limitation, liquid or gas (e.g., air)), hydrogen peroxide, and the like, and suitable combinations of any two or more thereof). When the second reactant is oxygen, the oxygen can be provided from the ambient air (in which case the optional second reactant storage unit 110 can be excluded), or from the second reactant storage unit 110. Similarly, when the second reactant is oxygen in water, the water can be provided from the second reactant storage unit 110, or from some other source, e.g., tap water (in which case the optional second reactant storage unit 110 can be excluded). In order to replenish the cathode, to deliver second reactant(s) to the cathodic area, and to facilitate ion exchange between the anodes and cathodes, a flow of the second reactant(s) can be maintained through a portion of the cells. This flow optionally can be maintained through one or more pumps (not shown in FIG. 1), blowers or the like, or through some other means. If the second reactant is air, it optionally can be pre-processed to remove CO₂ by, for example, passing the air through soda lime. This is generally known to improve performance of the fuel cell.

In this embodiment, the particulate fuel of the anodes is gradually consumed through electrochemical dissolution. In order to replenish the anodes, to deliver KOH to the anodes, and to facilitate ion exchange between the anodes and cathodes, a recirculating flow of the fluid borne zinc particles can be maintained through the cell cavities. This flow can be maintained through one or more pumps (not shown), convection, flow from a pressurized source, or through some other means.

As the potassium hydroxide contacts the zinc anodes, the following reaction takes place at the anodes:

Zn+4OH⁻→Zn(OH)₄²⁻+2e⁻ (1)

The two released electrons flow through a load to the cathode where the following reaction takes place:

$$\frac{1}{2} {O}_{2} + 2 {e}^{-} + {H}_{2} O \to 2 {OH}^{-} \qquad ( 2 )$$

The reaction product is the zincate ion, Zn(OH)₄²⁻, which is soluble in the reaction solution KOH. The overall reaction which occurs in the cell cavities is the combination of the two reactions (1) and (2). This combined reaction can be expressed as follows:

$$Zn + 2 {OH}^{-} + \frac{1}{2} {O}_{2} + {H}_{2} O \to {Zn ( OH )}_{4}^{2 -} \qquad ( 3 )$$

Alternatively, the zincate ion, Zn(OH)₄²⁻, can be allowed to precipitate to zinc oxide, ZnO, a second reaction product, in accordance with the following reaction:

Zn(OH)₄²⁻→ZnO+H₂O+2OH⁻ (4)

In this case, the overall reaction which occurs in the cell cavities is the combination of the three reactions (1), (2), and (4). This overall reaction can be expressed as follows:

$$Zn + \frac{1}{2} {O}_{2} \to ZnO \qquad ( 5 )$$

Under real world conditions, the reactions (4) or (5) yield an open-circuit voltage potential of about 1.4V. For additional information on this embodiment of a zinc/air battery or fuel cell, the reader is referred to U.S. Pat. Nos. 5,952,117; 6,153,329; and 6,162,555, which are hereby incorporated by reference herein as though set forth in full.

The reaction product ZN(OH)₄²⁻, and also possibly ZnO, can be provided to reaction product storage unit 104. Optional regeneration unit 106 can then reprocess these reaction products to yield oxygen, which can be released to the ambient air or stored in second reactant storage unit 110, and zinc particles, which are provided to fuel storage unit 108. In addition, the optional regeneration unit 106 can yield water, which can be discharged through a drain or stored in second reactant storage unit 110 or fuel storage unit 108. It can also regenerate hydroxide, OH⁻, which can be discharged or combined with potassium ions to yield the potassium hydroxide reaction solution.

The regeneration of the zincate ion, Zn(OH)₄²⁻, into zinc, and one or more second reactants can occur according to the following overall reaction:

$${Zn ( OH )}_{4}^{2 -} \to Zn + 2 {OH}^{-} + {H}_{2} O + \frac{1}{2} {O}_{2} \qquad ( 6 )$$

The regeneration of zinc oxide, ZnO, into zinc, and one or more second reactants can occur according to the following overall reaction:

$$ZnO \to Zn + \frac{1}{2} {O}_{2} \qquad ( 7 )$$

It should be appreciated that embodiments of metal fuel cells other than zinc fuel cells or the particular form of zinc fuel cell described above are possible for use in a system according to the invention. For example, aluminum fuel cells, lithium fuel cells, magnesium fuel cells, iron fuel cells, sodium fuel cells, and the like are possible, as are metal fuel cells where the fuel is not in particulate form but in another form such as without limitation sheets, ribbons, strings, slabs, plates, or the like, or suitable combinations of any two or more thereof. Embodiments are also possible in which the fuel is not fluid borne or continuously re-circulated through the cell cavities (e.g., porous plates of fuel, ribbons of fuel being cycled past a reaction zone, and the like). It is also possible to avoid an electrolytic reaction solution altogether or at least employ reaction solutions besides potassium hydroxide, for example, without limitation, sodium hydroxide, inorganic alkalis, alkali or alkaline earth metal hydroxides or aqueous salts such as sodium chloride. See, for example, U.S. Pat. No. 5,958,210, the entire contents of which are incorporated herein by this reference. It is also possible to employ metal fuel cells that output AC power rather than DC power using an inverter, a voltage converter, or the like, or suitable combinations of any two or more thereof.

In another embodiment of a fuel cell useful in the practice of the invention, the fuel used in the electrochemical reaction that occurs within the cells is hydrogen, the second reactant is oxygen, and the reaction product is water. In one aspect, the hydrogen fuel is maintained in the fuel storage unit 108, but the second reactant storage unit 110 can be omitted and the oxygen used in the electrochemical reaction within the cells can be taken from the ambient air. In another aspect, the hydrogen fuel is maintained in the fuel storage unit 108, and the oxygen is maintained in the second reactant storage unit 110. In addition, the optional reaction product storage unit 104 can be included or omitted, and the water resulting from discharge of the unit simply discarded or stored in the reaction product storage unit 104 (if present), respectively. Later, the optional regeneration unit 106 can regenerate water from another source, such as tap water or distilled water, or from the reaction product storage unit 104 (if present) into hydrogen and oxygen. The hydrogen can then be stored in fuel storage unit 104, and the oxygen simply released into the ambient air or maintained in the second reactant storage unit 110.

In a further embodiment of a fuel cell useful in the practice of the invention, a metal fuel cell system is provided. Such system is characterized in that it has one, or any suitable combination of two or more, of the following properties: the system optionally can be configured to not utilize or produce significant quantities of flammable fuel or product, respectively; the system can provide primary and/or auxiliary/backup power to the one or more loads for an amount of time limited only by the amount of fuel present (e.g., in the range(s) from about 0.01 hours to about 10,000 hours or more, and in the range(s) from about 0.5 hours to about 650 hours, or more); the system optionally can be configured to have an energy density in the range(s) from about 35 Watt-hours per kilogram of combined fuel and electrolyte (reaction medium) added to about 400 Watt-hours per kilogram of combined fuel and electrolyte added; the system optionally can further comprise an energy requirement and can be configured such that the combined volume of fuel and electrolyte added to the system is in the range(s) from about 0.0028 L per Watt-hour of the system's energy requirement to about 0.025 L per Watt-hour of the system's energy requirement, and this energy requirement can be calculated in view of, among other factors, the energy requirement(s) of the one or more load(s) comprising the system (In one embodiment, the energy requirement of the system can be in the range(s) from 50 Watt-hours to about 500,000 Watt-hours, whereas in another embodiment, the energy requirement of the system can be in the range(s) from 5 Watt-hours to about 50,000,000 Watt-hours; in yet another embodiment, the energy requirement can range from 5×10⁻¹² Watt-hours to 50,000 Watt-hours); the system optionally can be configured to have a fuel storage unit that can store fuel at an internal pressure in the range(s) from about −5 pounds per square inch (psi) gauge pressure to about 200 psi gauge pressure; the system optionally can be configured to operate normally while generating noise in the range(s) from about 1 dB to about 50 dB (when measured at a distance of about 10 meters therefrom), and alternatively in the range(s) of less than about 50 dB (when measured at a distance of about 10 meters therefrom). In one implementation, this metal fuel cell system comprises a zinc fuel cell system.

FIG. 1B is a block diagram of an alternative embodiment of a metal-based fuel cell in which, compared to FIG. 1A, like elements are referenced with like identifying numerals. Dashed lines are flow paths for the recirculating reaction solution when the optional regeneration unit is present and running. Solid lines are flow paths for the recirculating anode fluid when the fuel cell system is running in idle or discharge mode. As illustrated, in this embodiment, when the system is operating in the discharge mode, optional regeneration unit 106 need not be in the flow path represented by the solid lines.

An advantage of fuel cells relative to traditional power sources such as lead acid batteries is that they can provide longer term primary and/or auxiliary/backup power more efficiently and compactly. This advantage stems from the ability to continuously refuel the fuel cells using fuel stored with the fuel cell, from some other source, and/or regenerated from reaction products by the optional regeneration unit 106. In the case of the metal (e.g., zinc) fuel cell, for example, the duration of time over which energy can be provided is limited only by the amount of fuel and reaction medium (if used) which is initially provided in the fuel storage unit, which is fed into the system during replacement of a fuel storage unit 108, and/or which can be regenerated from the reaction products that are produced. Thus, the system, comprising at least one fuel cell that comprises an optional regeneration unit 106 and/or a replaceable fuel storage unit 108, can provide primary and/or auxiliary/backup power to the one or more loads for a time in the range(s) from about 0.01 hours to about 10000 hours, or even more. In one aspect of this embodiment, the system can provide back-up power to the one or more loads for a time in the range(s) from about 0.5 hours to about 650 hours, or even more.

Moreover, the system can optionally can be configured to expel substantially no reaction product(s) outside of the system (e.g., into the environment).

Embodiments of the Invention

The invention can be embodied in a fuel-cell based power source having internal redundancy for allowing continued operation of a load. Suitable loads include lawn and garden equipment; radios; telephone; targeting equipment; battery rechargers; laptops; communications devices; sensors; night vision equipment; camping equipment; lights; vehicles; torpedoes; security systems; electrical energy storage devices for renewable energy sources; other electrical devices; equipment for which a primary and/or backup power source is necessary or desirable to enable the equipment to function for its intended purpose; military-usable variants of any of the above; and suitable combinations of any two or more thereof. In one embodiment, an electric vehicle comprises a suitable load.

The fuel-cell based power source supplies electrical power to first and second power source terminals, and comprises a first plurality of fuel cell stacks, a second plurality of power converters, and a third plurality of bypass devices/diodes.

The first plurality (i.e., number of fuel cell stacks) has a value v, where v is any positive integer generally in the range(s) from 1 to 1000 or more. Each of the first plurality of fuel cell stacks can generate electrical power.

The second plurality (i.e., number of power converters) typically has a value w in the range from 1 to v. Each of the second plurality of power converters can be operably coupled to at least one of the first plurality of fuel cell stacks for receiving input electrical power from the fuel cell stack(s) and converting the input electrical power to output electrical power at a predetermined output voltage. This second plurality of power converters can be connected in series between the first and second power source terminals such that the voltage across the first and second power source terminals is the sum of the output voltages of the second plurality of power converters. Alternatively or in addition, each of the second plurality of power converters comprises input terminals that are operably coupled to at least one of the fuel cell stacks for receiving input electrical power from the fuel cell stack(s), and a positive output terminal and a negative output terminal for providing output electrical power at a predetermined output voltage, where the power converter is capable of converting the input electrical power to the output electrical power. Additionally or in the alternative, the second plurality of power converters are connected in series between the first and second power source terminal such that the voltage across the first and second power source terminals is the sum of the voltages at the output terminals of the power converters.

The third plurality (i.e., number of bypass devices/diodes) generally has a value x in the range from 1 to w. Each of the third plurality of bypass devices/diodes can be operably coupled to at least one of the second plurality of power converters for providing a current path around the respective power converter(s) if the respective power converter(s) do(es) not provide output electrical power. Alternatively or in addition, the third plurality of bypass devices comprises at least one silicon diode, optionally anti-parallel. In one embodiment, each bypass diode can comprise a cathode that is operably coupled to the positive output terminal and an anode that is operably coupled to the negative output terminal of each of at least one of the power converters for providing a current path between each power converter's output terminals if the respective power converter is unable to provide output electrical power.

In additional or alternative features of the invention, the predetermined output voltage of each power converter can be selectable from a fourth plurality, having a value of (y+1) in the range from 1 to x where y is the number of bypass device(s) that each provide a current path around power converter(s) that are not supplying power, of different converter output voltages. Each of the fourth plurality of different converter output voltages is typically orderable from the first to the (y+1)^{th} converter output voltage according to ascending voltage magnitude. For example, when (y+1)=3, there are three different converter output voltages, and the third converter output voltage is greater than the second converter output voltage and the second converter output voltage is greater than the first converter output voltage. In this configuration, a power converter can be set to the first output voltage if all of the power converters are supplying power, to the second output voltage if one of the power converters is not supplying power, and to the third output voltage if two of the power converters are not supplying power.

Alternatively or in addition, the value of y can be determined on an absolute scale (e.g., any positive integer in the range(s) from 1 to 1000 or more) or on a percentage scale relative to x (e.g., y is not greater than a percentage in the range(s) from about 10% to about 80% of x). For example, y can be 1, 2, 3, 4, 5, 6 or more. Alternatively or additionally, y can be configured such that y is not greater than about 10% of x, or, alternatively or additionally, not greater than about 30% of x, or, alternatively or additionally, not greater than about 50% of x.

In one example of a fuel-cell based power source, v can be at least 3, w can be at least 3, and y can be 2.

In another example of a fuel-cell based power source, v can be at least 8, w can be at least 8, x can be at least 4, y can be 3, and the voltage across the first and second power source terminals is about 180 volts, the first converter output voltage is about 22 volts, the second converter output voltage is about 26 volts and the third converter output voltage is about 30 volts. In one implementation of this example, the second plurality of power converters can comprise 8 power converters, such that w is 8.

The fuel-cell based power source can comprise a variety of different fuel cells. Thus, in one embodiment, the fuel-cell based power source can comprise a hydrogen fuel cell or a metal fuel cell. In one embodiment of the fuel-cell based power system, the fuel-cell based power source can comprise a zinc fuel cell. Alternatively or additionally, the fuel-cell based power system can comprise a fuel cell comprising one or more of the following properties: the fuel cell is configured to not utilize or produce significant quantities of flammable fuel or product, respectively; the fuel cell provides primary and/or auxiliary/backup power to one or more loads for an amount of time in the range from about 0.01 hours to about 10,000 hours; the fuel cell is configured to have an energy density in the range from about 35 Watt-hours per kilogram of combined fuel and reaction medium added to about 400 Watt-hours per kilogram of combined fuel and reaction medium added; the fuel cell comprises an energy requirement in the range from 5×10−12 Watt-hours to about 50,000,000 Watt-hours, and can be configured such that the combined volume of fuel and reaction medium added to the fuel cell is in the range from about 0.0028 L per Watt-hour of the fuel cell's energy requirement to about 0.025 L per Watt-hour of the fuel cell's energy requirement; the fuel cell comprises a fuel storage unit that can store fuel at an internal pressure in the range from about −5 pounds per square inch (psi) gauge pressure to about 200 psi gauge pressure; the fuel cell is configured to operate normally while generating noise in the range from about 1 dB to about 30 dB, when measured at a distance of about 10 meters therefrom.

In another aspect, the invention can be embodied in an electrochemical power source comprising the fuel-cell based power source in accordance with the invention.

In a further aspect, the invention can be embodied in a load comprising the fuel-cell based power source in accordance with the invention. Suitable loads can be selected from the group consisting of lawn and garden equipment; radios; telephone; targeting equipment; battery rechargers; laptops; communications devices; sensors; night vision equipment; camping equipment; lights; vehicles; torpedoes; security systems; electrical energy storage devices for renewable energy sources; other electrical devices; equipment for which a primary and/or backup power source is necessary or desirable to enable the equipment to function for its intended purpose; military-usable variants of any of the above; and suitable combinations of any two or more thereof. In one embodiment, the load comprises an electrical vehicle. The electrical vehicle can comprise a propulsion motor and a motor controller operably coupled to the propulsion motor, wherein the fuel-cell based power source is operably coupled to the motor controller for supplying electrical power to the propulsion motor.

In an additional aspect, the invention can be embodied in a method for modulating the voltage of a fuel-cell based power source for supplying electrical power to first and second power source terminals. Modulating the voltage can comprise one or more of reducing, maintaining or increasing the voltage(s), both of the fuel-cell based power source and/or its constituent fuel cell stack(s), depending on the application of the method. The method comprises identifying at least one power converter of the power source that is unable to provide output electrical power at a predetermined output voltage across a positive output terminal and a negative output terminal of the power converter. Typically, each of the power converter(s) of the power source is operably coupled to at least one fuel cell stack of the fuel-cell based power source for receiving input electrical power from the fuel cell stack(s) and is capable of providing output electrical power at the predetermined output voltage. The method further comprises providing a current path between the positive output terminal and the negative output terminal of at least one of the identified power converters that are not supplying power. The method optionally additionally comprises selecting an output voltage, different from the predetermined output voltage, for at least one of the power converter(s) of the power source for which a current path has not been provided in accordance with the step of providing a current path.

Alternatively or in addition, the predetermined output voltage for the method is selectable from a plurality, having a value of (y+1) where y is in the range from 0 to the number of power converter(s) of the power source, of different converter output voltages, each of the plurality of different converter output voltages being orderable from the first to the (y+1)^{th} converter output voltage according to ascending voltage magnitude.

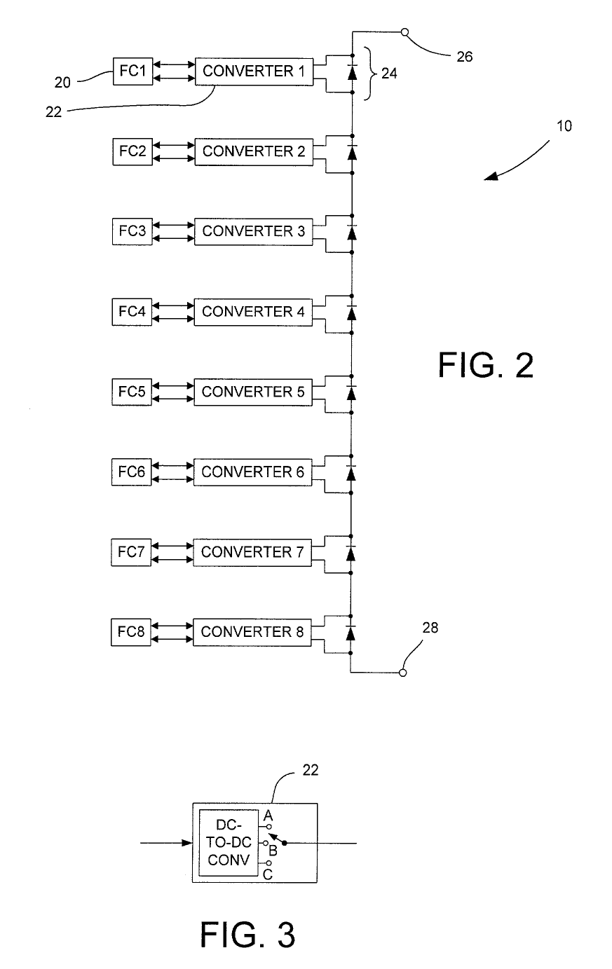

With reference to FIG. 1C, the invention can be embodied in a power source 10 having internal redundancy for allowing continued operation of a load such as an electric vehicle 12. The power source can be coupled to a motor controller 14 that controls electrical power provided to a propulsion motor 16. The propulsion motor is coupled to the vehicle's wheels for propelling the vehicle. With reference to FIG. 2, the power source comprises a plurality of fuel cell stacks 20, a plurality of power converters 22, and a plurality of bypass devices 24. Each power converter is coupled to one of the fuel cell stacks for receiving input electrical power from the fuel cell stack and converting the input electrical power to output electrical power at a predetermined direct current (dc) output voltage. The plurality of power converters are connected in series between first and second terminals, 26 and 28, of the power source such that the voltage of the power source is the sum of the output voltages of the plurality of power converters. Each bypass device is coupled to one of the power converters for providing a current path around the respective power converter if the power converter is unable to provide output electrical power.

In one embodiment, a configuration comprises 8 power converters having output terminals connected in series between the first and second terminals of the power source's bus. Each power converter can be a dc-to-dc power converter that is set to nominally supply 22.5 volts resulting in a source bus voltage of 180 volts.

With reference to FIG. 3, each power converter 22 can have first, second and third selectable output voltages, VA, VB and VC, respectively. The output voltages can be selected by switch positions, A, B and C. The third converter output voltage VC is greater than the second converter output voltage VB, which is greater than the first converter output voltage VA. With reference to FIG. 4, a power converter can be set to the first converter output voltage VnA (where n represents the power converters numbered 1 to 8) if all of the power converters are supplying power. The resulting supply bus voltage Vout is 8 times the individual converter output voltages VnA. With reference to FIG. 5, if one of the power converters, e.g., converter 6, is not supplying output power, the bypass device coupled to the converter allows the remaining operational power converters to supply power to the source bus. However, the output voltage Vout of the power source will have dropped. Although the voltage of the source bus is reduced, the electric vehicle 12 may still operate with reduced performance. With reference to FIG. 6, the operating power converters can be switched to the second converter output voltage VnB to return the source bus voltage Vout to its nominal value. Similarly, with reference to FIG. 7, if two of the power converters are not supplying power, e.g., converters 2 and 6, then the remaining operational converters can supply power to the source bus, and the voltage on the source bus can be returned to its nominal value by switching the power converters to the third converter output voltage.

In one embodiment, the first converter output voltage can be about 22 volts, the second converter output voltage can be about 26 volts, and the third converter output voltage can be about 30 volts. The vehicle's operator can manually switch the power converters 22 to the desired output voltage based on converter and source bus output voltage measurements. Alternatively, the converters can be automatically switched to the desired output voltage based on the output voltage measurements, via use of logic or some other means.

The bypass device 24 can be an anti-parallel silicon diode connected between the output terminals of the corresponding power converter 22. More specifically, the diode's cathode can be connected to the positive terminal, and the diode's anode can be connected to the negative terminal, of the corresponding power converter. When the power converter is operational, the diode is reverse biased and current is not shunted though the diode. However, if the output voltage of the power converter falls to zero, then the bypass diode becomes forward biased and provides a current path around the inoperative power converter.

The output voltage of a power converter 22 can fail for a variety of reasons. A likely reason is that the corresponding fuel cell stack 20 is not functioning properly. The cell's fuel source can be exhausted. Alternatively, the temperature of the fuel cell can be outside of nominal operating limits and the fuel cell can be intentionally shut down in an attempt to avoid permanent damage to the fuel cell.

The bypass diodes and the selectable converter output voltages allow the power source 10 to have internal series redundancy to more reliably provide power to the electric vehicle 12. As discussed above, the source bus voltage Vout can be maintained in the presence of more than one power converter 22 that is not providing output power.

While the invention has been illustrated and described in detail in the drawings and foregoing description, it should be understood the invention can be implemented though alternative embodiments within the spirit of the invention. Thus, the scope of the invention is not intended to be limited to the illustration and description in this specification, but is to be defined by the appended claims.

What is claimed is:

1. A fuel-cell based power source for supplying electrical power to first and second power source terminals, comprising:
a first plurality, having a value v, of fuel cell stacks, each fuel cell stack for generating electrical power;
a second plurality, having a value w in the range from 1 to v, of power converters, each power converter being operably coupled to at least one of the first plurality of fuel cell stacks for receiving input electrical power from the fuel cell stack(s) and converting the input electrical power to output electrical power at a predetermined output voltage, wherein the second plurality of power converters are connected in series between the first and second power source terminals such that the voltage across the first and second power source terminals is the sum of the output voltages of the second plurality of power converters; and
a third plurality, having a value x in the range from 1 to w, of bypass devices, each bypass device being operably coupled to at least one of the second plurality of power converters for providing a current path around the respective power converter(s) if the respective power converter(s) do(es) not provide output electrical power.

2. The fuel-cell based power source of claim 1, wherein the predetermined output voltage is selectable from a fourth plurality, having a value of (y+1) in the range from 1 to x where y is the number of bypass device(s) that each provide a current path around power converter(s) that are not supplying power, of different converter output voltages, each of the fourth plurality of different converter output voltages being orderable from the first to the (y+1)^{th} converter output voltage according to ascending voltage magnitude.

3. The fuel-cell based power source of claim 2, wherein y is not greater than 50% of x.

4. The fuel-cell based power source of claim 2, wherein y is not greater than 30% of x.

5. The fuel-cell based power source of claim 2, wherein y is not greater than 10% of x.

6. The fuel-cell based power source of claim 2, wherein y is 1.

7. The fuel-cell based power source of claim 2, wherein v is at least 3, w is at least 3, and y is 2.

8. The fuel-cell based power source of claim 2, wherein v is at least 8, w is at least 8, x is at least 4, y is 3, the voltage across the first and second power source terminals is about 180 volts, the first converter output voltage is about 22 volts, the second converter output voltage is about 26 volts and the third converter output voltage is about 30 volts.

9. The fuel-cell based power source of claim 1, wherein the third plurality of bypass devices comprises at least one silicon diode.

10. The fuel-cell based power source of claim 1, wherein the fuel-cell is a hydrogen fuel cell or a metal fuel cell.

11. The fuel-cell based power source of claim 10, wherein the fuel-cell is a metal fuel cell.

12. The fuel-cell based power source of claim 1, wherein the fuel-cell is a zinc fuel cell.

13. The fuel-cell based power source of claim 1, wherein the fuel-cell comprises one or more of the following properties: the fuel cell is configured to not utilize or produce significant quantities of flammable fuel or product, respectively; the fuel cell provides primary and/or auxiliary/backup power to one or more loads for an amount of time in the range from about 0.01 hours to about 10,000 hours; the fuel cell is configured to have an energy density in the range from about 35 Watt-hours per kilogram of combined fuel and reaction medium added to about 400 Watt-hours per kilogram of combined fuel and reaction medium added; the fuel cell comprises an energy requirement in the range from 5×10⁻¹² Watt-hours to about 50,000,000 Watt-hours, and can be configured such that the combined volume of fuel and reaction medium added to the fuel cell is in the range from about 0.0028 L per Watt-hour of the fuel cell's energy requirement to about 0.025 L per Watt-hour of the fuel cell's energy requirement; the fuel cell comprises a fuel storage unit that can store fuel at an internal pressure in the range from about −5 pounds per square inch (psi) gauge pressure to about 200 psi gauge pressure; the fuel cell is configured to operate normally while generating noise in the range from about 1 dB to about 30 dB, when measured at a distance of about 10 meters therefrom.

14. A fuel-cell based power source for supplying electrical power to first and second power source terminals, comprising:
a first plurality, having a value v, of fuel cell stacks, each fuel cell stack for generating electrical power;
a second plurality, having a value w in the range from 1 to v, of power converters, each power converter comprising input terminals that are operably coupled to at least one of the fuel cell stacks for receiving input electrical power from the fuel cell stack(s), and a positive output terminal and a negative output terminal for providing output electrical power at a predetermined output voltage, the power converter being capable of converting the input electrical power to the output electrical power;
a third plurality, having a value x in the range from 1 to w, of bypass diodes, each bypass diode comprising a cathode that is operably coupled to the positive output terminal and an anode that is operably coupled to the negative output terminal of each of at least one of the power converters for providing a current path between each power converter's output terminals if the respective power converter is unable to provide output electrical power;
wherein the second plurality of power converters are connected in series between the first and second power source terminal such that the voltage across the first and second power source terminals is the sum of the voltages at the output terminals of the power converters.

15. The fuel-cell based power source of claim 14, wherein the predetermined output voltage is selectable from a fourth plurality, having a value of (y+1) in the range from 1 to x where y is the number of bypass diode(s) that each provide a current path around power converter(s) that are not supplying power, of different converter output voltages, each of the fourth plurality of different converter output voltages being orderable from the first to the (y+1)^{th} converter output voltage according to ascending voltage magnitude.

16. The fuel-cell based power source of claim 15, wherein y is not greater than one-half of x.

17. The fuel-cell based power source of claim 15, wherein y is 1.

18. The fuel-cell based power source of claim 15, wherein v is at least 3, w is at least 3, and y is 2.

19. The fuel-cell based power source of claim 15, wherein v is at least 8, w is at least 8, x is at least 4, y is 3, the voltage across the first and second power source terminals is about 180 volts, the first converter output voltage is about 22 volts, the second converter output voltage is about 26 volts and the third converter output voltage is about 30 volts.

20. The fuel-cell based power source of claim 14, wherein the fuel-cell is a hydrogen fuel cell or a metal fuel cell.

21. The fuel-cell based power source of claim 20, wherein the fuel-cell is a metal fuel cell.

22. The fuel-cell based power source of claim 21, wherein the fuel-cell is a zinc fuel cell.

23. The fuel-cell based power source of claim 14, wherein the fuel-cell comprises one or more of the following properties: the fuel cell is configured to not utilize or produce significant quantities of flammable fuel or product, respectively; the fuel cell provides primary and/or auxiliary/backup power to one or more loads for an amount of time in the range from about 0.01 hours to about 10,000 hours; the fuel cell is configured to have an energy density in the range from about 35 Watt-hours per kilogram of combined fuel and reaction medium added to about 400 Watt-hours per kilogram of combined fuel and reaction medium added; the fuel cell comprises an energy requirement in the range from 5×10⁻¹² Watt-hours to about 50,000,000 Watt-hours, and can be configured such that the combined volume of fuel and reaction medium added to the fuel cell is in the range from about 0.0028 L per Watt-hour of the fuel cell's energy requirement to about 0.025 L per Watt-hour of the fuel cell's energy requirement; the fuel cell comprises a fuel storage unit that can store fuel at an internal pressure in the range from about −5 pounds per square inch (psi) gauge pressure to about 200 psi gauge pressure; the fuel cell is configured to operate normally while generating noise in the range from about 1 dB to about 30 dB, when measured at a distance of about 10 meters therefrom.

24. An electrochemical power source comprising the fuel-cell based power source of claim 1.

25. An electrochemical power source comprising the fuel-cell based power source of claim 14.

26. A load comprising the fuel-cell based power source of claim 1.

27. The load of claim 26, wherein the load is selected from the group consisting of: lawn and garden equipment; radios; telephone; targeting equipment; battery rechargers; laptops; communications devices; sensors; night vision equipment; camping equipment; lights; vehicles; torpedoes; security systems; electrical energy storage devices for renewable energy sources; other electrical devices; equipment for which a primary and/or backup power source is necessary or desirable to enable the equipment to function for its intended purpose; military-usable variants of any of the above; and suitable combinations of any two or more thereof.

28. The load of claim 27, wherein the load comprises an electric vehicle.

29. The load of claim 28, wherein the electric vehicle comprises a propulsion motor and a motor controller operably coupled to the propulsion motor, and wherein the fuel-cell based power source is operably coupled to the motor controller for supplying electrical power to the propulsion motor.

30. The load of claim 29, wherein the predetermined output voltage is selectable from a fourth plurality, having a value of (y+1) in the range from 1 to x where y is the number of bypass device(s) that each provide a current path around power converter(s) that are not supplying power, of different converter output voltages, each of the fourth plurality of different converter output voltages being orderable from the first to the (y+1)^{th} converter output voltage according to ascending voltage magnitude.

31. A load comprising the fuel-cell based power source of claim 14.

32. The load of claim 31, wherein the load is selected from the group consisting of: lawn and garden equipment; radios; telephone; targeting equipment; battery rechargers; laptops; communications devices; sensors; night vision equipment; camping equipment; lights; vehicles; torpedoes; security systems; electrical energy storage devices for renewable energy sources; other electrical devices; equipment for which a primary and/or backup power source is necessary or desirable to enable the equipment to function for its intended purpose; military-usable variants of any of the above; and suitable combinations of any two or more thereof.

33. The load of claim 32, wherein the load is comprises an electric vehicle.

34. The load of claim 33, wherein the electric vehicle comprises a propulsion motor and a motor controller operably coupled to the propulsion motor, and wherein the fuel-cell based power source is operably coupled to the motor controller for supplying electrical power to the propulsion motor.

35. The load of claim 34, wherein the predetermined output voltage is selectable from a fourth plurality, having a value of (y+1) in the range from 1 to x where y is the number of bypass device(s) that each provide a current path around power converter(s) that are not supplying power, of different converter output voltages, each of the fourth plurality of different converter output voltages being orderable from the first to the (y+1)^{th} converter output voltage according to ascending voltage magnitude.

36. A method for modulating the voltage of a fuel-cell based power source for supplying electrical power to first and second power source terminals, the method comprising:
a. identifying at least one power converter of the power source that is unable to provide output electrical power at a predetermined output voltage across a positive output terminal and a negative output terminal of the power converter, wherein each of the power converter(s) is operably coupled to at least one fuel cell stack of the fuel-cell based power source for receiving input electrical power from the fuel cell stack(s) and is capable of providing output electrical power at the predetermined output voltage; and
b. providing a current path between the positive output terminal and the negative output terminal of at least one of the identified power converters that are not supplying power.

37. The method of claim 36, wherein modulating the voltage comprises reducing the voltage.

38. The method of claim 36, wherein modulating the voltage comprises increasing the voltage.

39. The method of claim 36, wherein modulating the voltage comprises maintaining the voltage.

40. The method of claim 36, wherein the predetermined output voltage is selectable from a plurality, having a value of (y+1) where y is in the range from 0 to the number of power converter(s) of the power source, of different converter output voltages, each of the plurality of different converter output voltages being orderable from the first to the (y+1)^{th} converter output voltage according to ascending voltage magnitude.

41. The method of claim 40, further comprising selecting an output voltage, different from the predetermined output voltage, for at least one of the power converter(s) of the power source for which a current path has not been provided in accordance with step b.
